(19) United States
(12) Patent Application Publication
(10) Pub. No.: US 2025/0146753 A1
(43) Pub. Date: May 8, 2025

(54) ELECTRIC ARC FURNACE, METHOD FOR OPERATING AN ELECTRIC ARC FURNACE, AND USE OF AN ELECTRIC ARC FURNACE

(71) Applicant: SMS group GmbH, Dusseldorf (DE)

(72) Inventors: Hans Ferkel, Dusseldorf (DE); Markus Reifferscheid, Korschenbroich (DE); Thomas Henkel, Duisburg (DE); Ingo Schuster, Willich (DE)

(21) Appl. No.: 18/684,231

(22) PCT Filed: Aug. 17, 2022
(86) PCT No.: PCT/EP2022/072940

§ 371 Date: Feb. 16, 2024

(30) Foreign Application Priority Data
Aug. 18, 2021 (DE) 10 2021 121 472.6

(51) Int. Cl. F27B 3/28; F27D 19/00; F27D 21/00

(52) U.S. Cl. CPC F27B 3/28; F27D 21/00; F27D 2019/0006

(57) ABSTRACT

The invention relates to an electric arc furnace having a furnace vessel with at least one electrode and a voltage supply connected to the at least one electrode, wherein: the furnace vessel has a lower vessel for receiving a melt and a cover for placing onto the lower vessel; the lower vessel has a tapping channel; and the cover has a retaining means for fastening the at least one electrode; the electric arc furnace is designed to determine a nitrogen content in the melt; and/or the electric arc furnace is designed to reduce the nitrogen content in the melt to less than or equal to 55 ppm, preferably to less than or equal to 45 ppm and particularly preferably to less than or equal to 35 ppm. The invention further relates to an operating method and to a use of an electric arc furnace.

The invention relates to an electric arc furnace, a method for operating an electric arc furnace and a use of an electric arc furnace.

Steel production has a significant impact on CO₂ emissions in the industrial sector. This can be reduced by using an electric arc furnace, as less energy is required compared to a blast furnace. Furthermore, the use of electrical energy makes it possible to reduce the use of fossil fuels for steel production.

An electric arc furnace (often referred to as EAF for “electric arc furnace”) is used for the production of steel.

The electric arc furnace is charged with scrap, sponge iron (often referred to as DRI for “direct reduced iron”) and/or pig iron and the heat required for melting is provided by electrical energy and electric arcs.

The properties of steel are influenced by the carbon content, the nitrogen content and/or the content of other elements.

In non-set form, nitrogen can deposit at the grain boundaries and negatively influence the toughness of the steel and its susceptibility to stress corrosion cracking during the aging process. Furthermore, controlled microstructure and texture formation during deep drawing, high surface quality and low remagnetization losses can be linked to low nitrogen contents.

The object of the invention is that of providing an improvement over or an alternative to the prior art.

According to a first aspect of the invention, the object is achieved by an electric arc furnace having a furnace vessel with at least one electrode and a voltage supply connected to the at least one electrode, wherein the furnace vessel has a lower vessel for the receptacle of a melt and a cover for placing on the lower vessel, wherein the lower vessel has a tapping channel, and wherein the cover has a retaining means for fastening the at least one electrode, wherein the electric arc furnace is configured to determine a nitrogen content in the melt and/or wherein the electric arc furnace is configured to reduce the nitrogen content in the melt to less than or equal to 70 ppm, preferably to less than or equal to 55 ppm and particularly preferably to less than or equal to 45 ppm.

In this regard, the following is explained conceptually:
First of all, it should be expressly indicated that, in the context of this description, indefinite articles and numbers such as “one”, “two”, etc. are generally to be understood as “at least” indications, i.e. as “at least one . . . ”, “at least two . . . ”, etc., unless it is expressly apparent from the respective context or it is obvious or technically mandatory for the person skilled in art that only “exactly one . . . ”, “exactly two . . . ”, etc. can be meant there.

In the context of this description, the term “particularly” is always to be understood as introducing an optional and/or preferred feature. The expression should not be understood to mean “specifically” or “namely.”

An “electric arc furnace” is a space at least partially enclosed by a “furnace vessel” which is configured to supply heat to the material in the furnace vessel using an electric arc emanating from at least one “electrode”, whereby the material can be melted. The melting process can optionally be accelerated by chemical energy, particularly by injecting oxygen and/or other fuel-gas mixtures, which can, however, increase the CO₂ emissions of the process.

The furnace vessel has the lower vessel for receiving the melt and the cover, wherein the electric arc furnace, the furnace vessel or, preferably, the cover has the “retaining means” for retaining the at least one electrode. The retaining means is preferably designed in such a manner that the at least one electrode can be displaced relative to the cover of the furnace vessel. In other words, the retaining means is designed in such a manner that the at least one electrode can be adjusted with respect to an immersion depth in the furnace vessel, whereby it is possible to react advantageously to a changing filling level in the furnace vessel.

In accordance with an appropriate embodiment, the furnace vessel is open in at least one area. In other words, the furnace vessel is suitably designed in such a manner that pressure equalization between the furnace vessel and the environment surrounding the furnace vessel is possible and/or gas exchange between the furnace vessel and the environment surrounding the furnace vessel is possible.

The cover of the furnace vessel is optionally mounted eccentrically to the lower vessel in such a manner that the weight of the cover does not have to be supported by an upper structure in the open state. The lower vessel preferably has an elliptical cross-section, at least in some areas. A lower vessel can optionally be designed in such a manner that it has a stem in relation to the cover, which optionally accommodates the tapping channel at least in certain areas.

Preferably, the electric arc furnace has a temperature sensor, which is configured to detect the temperature of the melt. The temperature sensor is conveniently connected to a data acquisition and/or evaluation unit and can provide it with the measurement data.

The lower vessel of the furnace vessel is preferably configured for the receptacle of more than or equal to 100 tons of melt, further preferably of more than or equal to 150 tons, particularly preferably of more than or equal to 200 tons and further particularly preferably of more than or equal to 400 tons. In addition to the melt, the lower vessel is suitably configured for the receptacle of a slag, particularly a foam slag. Furthermore, the lower vessel is suitably configured to receive a melt as well as a sump, particularly a sump with a weight corresponding to more than or equal to 15 wt. % of a tapping weight of the electric arc furnace, preferably more than or equal to 30 wt. %, further preferably more than or equal to 40 wt. % and particularly preferably more than or equal to 50 wt. %.

The number of electrodes can vary depending on the design of the electric arc furnace. The arc emanating from the at least one electrode generates temperatures of up to 3500° C., which means that even difficult-to-melt alloying elements such as tungsten and molybdenum can be melted down by an electric arc furnace. Preferably, an electrode has a current-carrying capacity of more than or equal to 90 kA, further preferably a current-carrying capacity of more than or equal to 120 kA and particularly preferably a current-carrying capacity of more than or equal to 130 kA.

Optionally, the electric arc furnace is configured to produce a melt with an iron content of greater than or equal to 75 wt. %, preferably with an iron content of greater than or equal to 80 wt. % and particularly preferably with an iron content of greater than or equal to 85 wt. %. Further preferably, the electric arc furnace is configured to produce a melt with an iron content of greater than or equal to 90 wt. %, preferably with an iron content of greater than or equal to 93 wt. % and particularly preferably with an iron content of greater than or equal to 95 wt. % or 97 wt. %. The scrap used for the production of the molten steel optionally has, in relation to the solid starting materials with which the electric arc furnace is charged, a part of greater than or equal to 1 wt. % and less than or equal to 5 wt. %, preferably a part of less than or equal to 10 wt. % and particularly preferably a part of less than or equal to 15 wt. %. Further preferably, the scrap used has a part of less than or equal to 20 wt. %, preferably a part of less than or equal to 25 wt. % and particularly preferably a part of less than or equal to 30 wt. %.

The solid starting materials used for the production of the molten steel preferably have an average carbon content of more than or equal to 0.1 wt. %, preferably an average carbon content of more than or equal to 0.2 wt. % and particularly preferably an average carbon content of more than or equal to 0.3 wt. %. Further preferably, the solid starting materials have an average carbon content of more than or equal to 0.4 wt. %, preferably an average carbon content of more than or equal to 0.5 wt. % and particularly preferably an average carbon content of more than or equal to 0.6 wt. %.

The solid starting materials used for the production of the molten steel optionally have an average nitrogen content of more than or equal to 30 ppm, further optionally an average nitrogen content of more than or equal to 50 ppm and also optionally an average nitrogen content of more than or equal to 70 ppm. Optionally, the solid starting materials used for the production of the molten steel have an average nitrogen content of more than or equal to 90 ppm, optionally an average nitrogen content of more than or equal to 110 ppm and further optionally an average nitrogen content of more than or equal to 130 ppm. An average nitrogen content in the melt of up to 210 ppm is also conceivable.

A “voltage supply” is understood to be an apparatus configured to provide electrical energy. Depending on the design of the electric arc furnace, the voltage supply can be configured to provide an alternating voltage or a direct voltage. Preferably, the voltage supply is configured to provide an electrical output of more than or equal to 120 MW, more preferably more than or equal to 160 MW and particularly preferably more than or equal to 200 MW.

Optionally, the at least one electrode is surrounded by a gas mixture having nitrogen during operation of the electric arc furnace, particularly by a gas mixture having more than or equal to 30 vol. % nitrogen.

An arc in an electric arc furnace has plasma. Any dissociated nitrogen in the plasma can lead to an increase in the nitrogen content in the iron-containing melt compared to the nitrogen content of the solid starting materials used.

When the melt is tapped, it is not protected from the surrounding atmosphere by a slag, such that the nitrogen content in the melt is again in direct exchange with the surrounding atmosphere, which can increase the nitrogen content in the melt.

The electric arc furnace conveniently has a means of suppressing or reducing a longitudinal vortex in the melt stream. The designated melt exiting through the tapping channel can be in an active connection to this means, which suppresses or reduces a longitudinal vortex in the melt stream, particularly a vortex braker. This can reduce the surface area of the emerging melt, which can reduce an increase in the nitrogen content from the surrounding environment during the tapping of the melt.

Optionally, no inert gas is supplied to the furnace vessel, particularly no gas mixture having an inert gas content of more than or equal to 10 vol. % is supplied to the furnace vessel.

In accordance with a preferred embodiment, in contrast to the oxygen contained in the free atmosphere, the furnace vessel is not supplied with a gas mixture which has an oxygen content of greater than or equal to 1 vol. %. By adding additional oxygen, the cooking reaction in the electric arc furnace can be intensified, but this also increases the CO₂ emissions of the process. In other words, the addition of a gas with an oxygen content of greater than or equal to 22 vol. % is preferably avoided.

With increasing requirements for some steel grades, the importance of a low nitrogen content is increasing, at least for these steel grades.

This means that determining the nitrogen content in the molten steel in an electric arc furnace is also becoming increasingly important. In the prior art, it is known that a sample is taken from the molten steel, which is analyzed with a gas chromatograph after cooling. However, this process requires a time delay between sampling and a result value for the nitrogen content, which would make the operation of the electric arc furnace uneconomical if the melt were to remain in the electric arc furnace until the determined nitrogen content is available and any subsequent further de-nitrification.

According to the invention, an electric arc furnace is provided which preferably has a means for at least indirectly determining the nitrogen content in the melt.

For this purpose, the electric arc furnace is suitably connected to a data acquisition and/or evaluation unit, wherein the data acquisition and/or evaluation unit is configured at least indirectly to determine the nitrogen content in the melt.

A “data processing and evaluation unit” is an electronic component that is configured to process and evaluate data. In particular, a data processing and evaluation unit may have a processor which is configured for data processing. A data processing and evaluation unit pursues the objective of organized handling of data, wherein information can be obtained from data and data can be compared and/or changed. Preferably, the data processing and evaluation unit is configured to determine the nitrogen content in the melt, taking into account the chemical and physical interactions.

Among other things, a computer-aided means of determining the nitrogen content in the melt is proposed here.

The data processing and evaluation unit can be configured to compare measured values, in particular simultaneous measured values and/or a time series of measured values, in particular a time series of measured values of a current operating period of the electric arc furnace, and/or operating point parameters of the electric arc furnace with reference values, in particular with empirical values and/or with values determined by means of a mathematical model and/or with numerical simulation values, for which the nitrogen content in the melt is already known in each case, and to determine the nitrogen content in the melt by assignment by means of the comparison, in particular by interpolation between the comparison values.

Preferably, an adjustment takes place in the time range and/or after a fast Fourier transformation of the data (also FFT for “Fast Fourier Transformation”) in the frequency range.

In accordance with a particularly simple but expedient first alternative embodiment, a measured time since the start of the melting process and/or since the start of a cooking process in the electric arc furnace can thus serve as an example of an operating point parameter of the electric arc furnace for determining the nitrogen content in the melt.

Optionally, the comparative values used for comparison have a dependence on the composition of the starting materials and/or on the quantity of the starting materials and/or on the composition of one or more aggregates, particularly DRI, and/or on the quantity of one or more aggregates and/or on one or more operating point parameters of the electric arc furnace and/or on the dynamics of the cooking reaction in the electric arc furnace and/or on the intensity of the cooking reaction in the electric arc furnace.

Preferably, the development of the measured values over time is also taken into account in comparison with the development of the reference values over time.

This makes it possible to advantageously determine the nitrogen content in the melt simultaneously or with a time delay of less than or equal to 30 seconds, preferably less than or equal to 20 seconds and particularly preferably less than or equal to 10 seconds. This allows the operating parameters of the electric arc furnace to be adjusted and/or the components of the melt to be changed by adding aggregates depending on the nitrogen content determined. In other words, the electric arc furnace is set up for simultaneous determination of the nitrogen content in the melt, in particular during operation of the electric arc furnace.

According to a second alternative embodiment proposed here, the electric arc furnace has a sensor or combinations of sensors at least as a component of a means for at least indirectly determining the nitrogen content in the melt, in particular the sensor can be an acceleration sensor.

Among other things, an acceleration sensor attached to the electric arc furnace can be used to detect the dynamics and/or intensity of the cooking movement in the electric arc furnace. Preferably, the measurement data from the acceleration sensor can be reduced to the frequency range relating to the cooking movement using one or more filters. Among other things, the data obtained with an acceleration sensor can be used to determine the de-carburization rate and, coupled with this, the de-nitrification rate due to the partial pressure effects. If the average carbon content and/or the average nitrogen content of the starting materials and/or the additives are known, the nitrogen content in the melt can be determined based on this starting point, in particular using the previous cooking time and the values achieved so far for the de-carburization rate and/or the de-nitrification rate.

According to a third alternative embodiment, the electric arc furnace has a pressure sensor at least as a component of a means for at least indirectly determining the nitrogen content in the melt. Optionally, the pressure sensor is operatively connected to the pressure above the melt level in the furnace vessel.

The pressure sensor can be used to determine the amount of gas that has already been outgassed from the melt during the cooking process, in particular taking into account the increase in pressure in a closed furnace vessel. The nitrogen content in the melt can thus be determined using the known partial pressure effects and the known compositions of the starting materials and/or the additives. As a variant to the pressure sensor, any other means of determining the amount of gas already outgassed can also be used, particularly a flow sensor between the furnace and a gas extraction system and/or the free atmosphere in the environment of the electric arc furnace.

Since the boiling reaction is influenced by the respective partial pressures and the speed of the boiling movement depends on the dependence of the thermal state variables of the gases, particularly on the static pressure above the melt level in the furnace vessel, an optional pressure sensor as a component of a means for at least indirect determination of the nitrogen content advantageously enables the nitrogen content in the melt to be determined.

In accordance with a fourth alternative embodiment proposed herein, the electric arc furnace has, at least as a component of a means for at least indirectly determining the nitrogen content in the melt, a sensor for determining the concentration of a gas in the exhaust air of the electric arc furnace.

Preferably, this sensor is a sensor for determining the carbon monoxide content and/or the carbon dioxide content and/or the nitrogen content. As the respective gases are coupled in terms of their formation during the cooking process via the partial pressure effects, the nitrogen content in the melt can be determined based on the mean carbon content and/or the mean nitrogen content of the starting materials and/or aggregates.

It should be expressly indicated that each proposed embodiment of a component of a means for at least indirectly determining the nitrogen content in the melt can be combined with one or more other embodiments of a component of a means for at least indirectly determining the nitrogen content in the melt, either individually or cumulatively in any combination. The same applies to a combination with a data acquisition and/or evaluation unit.

To reduce the nitrogen content of a steel melt, a de-nitrification system is known to be installed downstream of the melting process and outside the furnace vessel, which removes nitrogen from the melt by means of a vacuum acting on the melt.

An electric arc furnace is now proposed here, which is preferably configured to reduce the nitrogen content in the melt to less than or equal to 70 ppm, further preferably to less than or equal to 55 ppm and particularly preferably to less than or equal to 45 ppm.

Preferably, the electric arc furnace is configured to reduce the nitrogen content in the melt to less than or equal to 50 ppm, preferably to less than or equal to 40 ppm and particularly preferably to less than or equal to 35 ppm. Further preferably, the electric arc furnace is configured to reduce the nitrogen content in the melt to less than or equal to 30 ppm, preferably to less than or equal to 25 ppm and particularly preferably to less than or equal to 20 ppm.

It should be expressly indicated that the above values for the nitrogen content are not to be understood as sharp limits, but rather can be exceeded or fallen short of on an engineering scale without departing from the described aspect of the invention. In simple terms, the values are intended to provide an indication of the size of the nitrogen content proposed here.

Among other things, it may be provided that additional aggregates are fed to the electric arc furnace, particularly aggregates containing ferrous and carbonaceous materials, preferably DRI. Preferably, more than or equal to 50 kg of carbon per minute are fed into the melt, preferably more than or equal to 80 kg of carbon per minute, further preferably more than or equal to 100 kg of carbon per minute and particularly preferably more than or equal to 150 kg of carbon per minute, wherein this amount of carbon is further preferably consumed with the cooking reaction. Optionally, oxygen can be added to the melt to accelerate the cooking reaction. The carbon input leads to a cooking reaction in connection with the dissolved oxygen in the melt and any artificially supplied oxygen,

$${[ C ]}_{dissolved} + {[ O ]}_{dissolved} = {\{ CO \}}_{gaseous}$$

$$or$$

$${2 [ C ]}_{dissolved} + {[ {O}_{2} ]}_{gaseous} = 2 {\{ CO \}}_{gaseous}$$

which counteracts any nitrogen absorption during the melting process in the electric arc furnace and/or leads to de-nitrification of the melt as a result of the partial pressure effect.

Optionally, an aggregate containing iron and carbon may have liquid and/or solid de-sulphurized iron.

In accordance with a preferred embodiment, the electric arc furnace is configured to achieve an average de-carburization rate of greater than or equal to 30 ppm/min, preferably greater than or equal to 40 ppm/min and particularly preferably greater than or equal to 50 ppm/min.

The de-nitrification of the melt can be accelerated by lowering the static pressure above the melt level in the furnace vessel. The electric arc furnace can therefore have an apparatus for lowering the static pressure above the melt level in the furnace vessel.

The electric arc furnace is conveniently configured so that the melting of the starting materials and the de-nitrification of the melt are completed in less than or equal to 45 minutes, preferably in less than or equal to 35 minutes and particularly preferably in less than or equal to 30 minutes. Furthermore, the electric arc furnace is preferably configured so that the melting of the starting materials and the de-nitrification of the melt are completed in less than or equal to 27 minutes, preferably in less than or equal to 25 minutes and particularly preferably in less than or equal to 23 minutes.

In accordance with a particularly preferred embodiment, the electric arc furnace has a conveyor system for conveying a carbon carrier, particularly for conveying directly reduced iron.

In this regard, the following is explained conceptually:
A “carbon carrier” is understood to mean any gaseous and any solid carbon carrier. A gaseous carbon carrier is particularly carbon monoxide, carbon dioxide and/or any hydrocarbon. In the case of a solid carbon carrier, DRI and/or pelletized DRI should particularly be considered.

A “conveyor system” is configured to convey the carbon carrier into the electric arc furnace, preferably at least indirectly into the molten phase of the starting materials in the electric arc furnace. To accelerate the cooking reaction, the conveyor system is configured to convey the carbon carrier during operation of the electric arc furnace. Preferably, the conveyor system has an adjustment variable and is configured for continuous and/or discontinuous conveying of the carbon carrier, wherein the aim is preferably to achieve a cooking reaction that is as homogeneous as possible. Optionally, the conveyor system is configured to convey the carbon carrier into a stem of the furnace vessel.

In accordance with a first alternative embodiment, a conveyor system is envisaged which is configured to convey a solid carbon carrier in the form of a bulk material into the furnace vessel. Among other things, this could be a bulk device and/or a belt conveyor system and/or a chain conveyor system.

According to a second alternative embodiment, a conveyor system is envisaged which is configured to wind a carbon carrier formed into a wire into the furnace vessel.

In accordance with a third alternative embodiment, a conveyor system is envisaged which is configured to inject a gaseous carbon carrier into the furnace vessel, preferably with a reactive inert gas, particularly argon.

According to a fourth alternative embodiment, the conveyor system is configured to blow a fine-grained carbon carrier, particularly the fine fraction of DRI, into the furnace vessel.

It should be expressly indicated that any proposed embodiment of a conveyor system may be combined with one or more other embodiments of a conveyor system, either individually or cumulatively in any combination.

The use of directly reduced iron as a carbon carrier to accelerate the cooking reaction leads to a comparatively low CO₂ emission of the overall process, as the iron oxide does not have to be melted for direct reduction and thus energy can be saved for the reduction of the iron oxide. Furthermore, the iron oxide is preferably directly reduced with a hydrogen-rich gas, particularly with hydrogen and/or with natural gas. This can advantageously achieve a comparatively pure direct-reduced iron, particularly with a carbon content of less than or equal to 0.5 wt. %, preferably 1.5 wt. % and particularly preferably 2.5 wt. %, which can be used directly instead of pig iron for steel production.

The conveyor system proposed here makes it possible to intervene in the cooking reaction in the electric arc furnace as required, so that the de-carburization and/or de-nitrification of the melt can be driven forward in an energy-optimized and/or time-optimized and/or emission-optimized manner.

Optionally, the electric arc furnace and/or the conveyor system is configured to convey the carbon carrier at a temperature of the carbon carrier of more than or equal to 500° C., preferably of more than or equal to 600° C. and particularly preferably of more than or equal to 700° C.

An electric arc furnace with a conveyor system is proposed here, which has a temperature resistance suitable for transporting a hot carbon carrier according to the specified values. A conveyor system for conveying DRI, which is preferably structurally connected to a system for the direct reduction of iron oxide, is preferable. This means that the DRI heated for direct reduction can be used directly for steel production without cooling down first, which saves energy in relation to the overall process and speeds up the melting process.

In accordance with a particularly preferred embodiment, the iron oxide is directly reduced with hydrogen, which has previously been produced using green current. This has the advantage of further reducing CO₂ emissions in relation to the overall process.

The electric arc furnace and/or the conveyor system for conveying the carbon carrier during operation of the electric arc furnace is suitably configured, particularly for continuous conveying of the carbon carrier.

In this regard, the following is explained conceptually:
A conveyor system which is configured to convey the carbon carrier “during operation of the electric arc furnace” is understood to mean that the conveyor system is configured to convey the carbon carrier during operation of at least one electrode and/or during the supply of artificially supplied oxygen. In this manner, the electric arc furnace process can be shortened, allowing more time for de-carburization and/or de-nitrification of the melt in conjunction with the designated downstream steelworks.

Particularly preferably, the electric arc furnace and/or the conveyor system can be controlled with regard to the quantity of carbon carrier conveyed, particularly with regard to the conveyor speed of the conveyor system.

In this regard, the following is explained conceptually:
A “controllable” electric arc furnace and/or a “controllable” conveyor system is understood to mean an electric arc furnace and/or a conveyor system that has a control. A control is understood as a method in which a variable quantity is automatically approximated to a specified nominal value, wherein the nominal value can also be time-variant. One property of a control is that the value of a variable to be controlled is determined as an actual value and, if it deviates from the desired nominal value, the value of a nominal variable is changed so that the value of the variable to be controlled approaches the nominal value again.

A suitable nominal variable can particularly be a control variable of the conveyor system, which has an impact on the conveyor speed of the conveyor system and thus at least indirectly also on the quantity of carbon carrier conveyed per unit of time.

A control can be carried out by a person by detecting a deviation between the actual value and nominal value and adjusting a value of a nominal variable on an actuator.

Alternatively, control can be carried out fully electronically by detecting an actual value by means of a measuring apparatus, comparing it with the nominal value by means of a data acquisition and/or evaluation unit and converting any deviation into a value for a control variable, wherein the value for the control variable is passed on to an actuator and wherein the actuator is configured to adjust the control variable by means of an electronic value specification. In the latter case, the actuator must have an electrical actuator to change the nominal variable.

In accordance with a particularly preferred embodiment, a data acquisition and/or evaluation unit is configured to execute an automated control algorithm and to transmit the calculated control values to the corresponding actuators so that the electric arc furnace can be controlled autonomously by means of the data acquisition and/or evaluation unit.

The data acquisition and/or evaluation unit can usefully evaluate the measured values of several and/or different measuring apparatus simultaneously, particularly in real time, and make them available to a control algorithm for use.

Optionally, a control algorithm has a method from the area of artificial intelligence, in particular the control algorithm uses a neural network.

Preferably, an electronic regulator for an electric arc furnace and/or for a conveyor system of an electric arc furnace has a PD regulator, which is a comparatively fast regulator, whereby the time until the nominal value is reached can be reduced even in the case of a comparatively large electric arc furnace with the tapping weight proposed above.

Among other things, an electric arc furnace is proposed here, the control of which is directed to a change in the composition of the exhaust gas of the electric arc furnace and/or to a change in the composition of the melt, in particular to reaching a nominal value proposed here for the nitrogen content of the melt. Preferably, the control is configured to achieve a nitrogen content in the melt currently in the electric arc furnace of less than or equal to 70 ppm, preferably less than or equal to 55 ppm and particularly preferably less than or equal to 45 ppm.

Preferably, the control is configured in such a way that an actual value of a controlled variable is used to determine at least one control value for the next batch, whereby cross-batch control can be achieved.

In accordance with a preferred embodiment of the control, the static pressure in the furnace vessel above the melting level and/or the carbon monoxide content in the exhaust gas of the electric arc furnace and/or the carbon dioxide content in the exhaust gas of the electric arc furnace and/or the nitrogen content in the exhaust gas of the electric arc furnace is used as the measured value.

Optionally, the electric arc furnace and/or the conveyor system is controlled in such a way that the melt has a carbon content of less than or equal to 2.06 wt. %.

Among other things, it is proposed here to control the electric arc furnace and/or the conveyor system in such a way that the controlled variable is the carbon content of the melt, wherein a carbon content of less than or equal to 2.06 wt. % is aimed at achieving a steel melt.

It will be understood that the control of the carbon content of the melt can also be combined with the above proposed control of the nitrogen content of the melt, without departing from the aspect of the invention described herein.

Optionally, the control is based on a measured time since the start of the melting process and/or since the start of the cooking process in the electric arc furnace.

Preferably, the control is based on one or more measured values, particularly a measured value of an acceleration sensor and/or a measured value of a pressure sensor and/or a measured value of a sensor for determining the concentration of a gas in the exhaust air of the electric arc furnace, preferably for determining the carbon monoxide concentration and/or the carbon dioxide concentration and/or the nitrogen concentration.

Optionally, the control has a method from the area of artificial intelligence, in particular the control algorithm uses a neural network.

A suitable nominal variable can particularly be a control variable of the conveyor system, which has an impact on the conveyor speed of the conveyor system and thus at least indirectly also on the quantity of carbon carrier conveyed per unit of time.

Preferably, the control is configured to achieve a carbon content of the melt of less than or equal to 0.65 wt. %, preferably a carbon content of less than or equal to 0.02 wt. %.

In accordance with an optional embodiment, the electric arc furnace has an apparatus for the insertion of artificially offered oxygen, particularly for the direct insertion of artificially offered oxygen into the melt and/or the furnace vessel.

Here it is proposed to provide the melt with an artificial oxygen supply. This can accelerate the cooking reaction. The amount of oxygen offered can be determined, among other things, by the regulator proposed above for achieving a defined carbon content in the melt and/or by the regulator for achieving a defined nitrogen content in the melt, wherein the amount of artificially offered oxygen is adjusted with a nominal variable which is operatively related to the amount of artificially offered oxygen.

The electric arc furnace is conveniently configured to remove nitrogen in a gas phase.

This can advantageously accelerate the de-nitrification of the melt. Among other things, it should be borne in mind that the nitrogen is removed at a static pressure in the furnace vessel of less than or equal to the standard air pressure at sea level, particularly less than or equal to 101,325 N/m², preferably less than or equal to 95,000 N/m² and particularly preferably less than or equal to 90,000 N/m².

Preferably, the voltage supply has a control that is operatively connected to the temperature of the melt.

This can save energy, as the control is preferably aimed at preventing or reducing the melt from reaching unnecessarily high temperatures.

It is understood that a control of the temperature of the melt via a nominal variable of the voltage supply can be combined with a control of the nitrogen content of the melt and/or with a control of the carbon content of the melt, without departing from the aspect of the invention presented here.

The electric arc furnace is preferably suitable for producing a melt having the following chemical composition:
maximum 0.02 wt. % carbon, preferably less than 0.01 wt. % carbon;
0.01 to 3.5 wt. % silicon, preferably less than 0.1 wt. % silicon;
maximum 2.5 wt. % manganese, preferably less than 1.0 wt. % manganese;
0.01 to 0.20 wt. % copper, preferably less than 0.15 wt. % copper;
maximum 0.40 wt. % chromium and nickel, preferably less than 0.20 wt. % chromium and nickel;
niobium, titanium, vanadium and boron with less than 0.10 wt. % each, preferably titanium, vanadium and boron with less than 0.05 wt. %;
maximum 70 ppm nitrogen, preferably less than 50 ppm nitrogen;
optionally other elements without iron with a part of less than 1.0 wt. %, which are deliberately alloyed or which enter the melt as an unavoidable admixture via the starting materials; and
residual iron content.

Optionally, the electric arc furnace has a melt with the above chemical composition.

According to a second aspect of the invention, the object is solved by a method of operating an electric arc furnace in accordance with the first aspect of the invention, wherein a melt is produced with a nitrogen content of less than or equal to 70 ppm, preferably less than or equal to 55 ppm and particularly preferably less than or equal to 45 ppm.

It will be understood that the above-described advantages of the electric arc furnace according to the first aspect of the invention extend directly to the method proposed herein for operating the electric arc furnace according to the first aspect of the invention.

Optionally, the nitrogen content in the melt can be determined during operation of the electric arc furnace.

The nitrogen content in the melt can be determined indirectly or directly, particularly using the methods explained with the first aspect of the invention. This is an advantageous way of directly monitoring the results of the nitrogen content achieved and/or providing feedback on the nitrogen content for the use of a controller and/or control.

The electric arc furnace and/or a conveyor system and/or a voltage supply are conveniently controlled.

In this way, the controlled variable nitrogen content in the melt and/or the controlled variable temperature of the melt can be controlled, whereby a controlled operation of the electric arc furnace can be achieved from a superordinate point of view, particularly an operation of the electric arc furnace optimized for CO₂ emissions and/or a melt quality to be achieved.

The method is preferably suitable for producing a melt having the following chemical composition:
maximum 0.02 wt. % carbon, preferably less than 0.01 wt. % carbon;
0.01 to 3.5 wt. % silicon, preferably less than 0.1 wt. % silicon;
maximum 2.5 wt. % manganese, preferably less than 1.0 wt. % manganese;
0.01 to 0.20 wt. % copper, preferably less than 0.15 wt. % copper;
maximum 0.40 wt. % chromium and nickel, preferably less than 0.20 wt. % chromium and nickel;
niobium, titanium, vanadium and boron with less than 0.10 wt. % each, preferably titanium, vanadium and boron with less than 0.05 wt. %;
maximum 70 ppm nitrogen, preferably less than 50 ppm nitrogen;
optionally other elements without iron with a part of less than 1.0 wt. %, which are specifically alloyed or which enter the melt as an unavoidable admixture via the starting materials; and
residual iron content.

It should be expressly noted that the subject matter of the second aspect can advantageously be combined with the subject matter of the preceding aspect of the invention, both individually or cumulatively in any combination.

According to a third aspect of the invention, the object is achieved by using an electric arc furnace according to the first aspect of the invention for the production of a melt with a nitrogen content of less than or equal to 70 ppm, preferably less than or equal to 55 ppm and particularly preferably less than or equal to 45 ppm.

It is to be understood that the advantages of the electric arc furnace according to the first aspect of the invention described above extend directly to the use of the electric arc furnace according to the first aspect of the invention.

The electric arc furnace can be used to produce a melt having the following chemical composition:
maximum 0.02 wt. % carbon, preferably less than 0.01 wt. % carbon;
0.01 to 3.5 wt. % silicon, preferably less than 0.1 wt. % silicon;
maximum 2.5 wt. % manganese, preferably less than 1.0 wt. % manganese;
0.01 to 0.20 wt. % copper, preferably less than 0.15 wt. % copper;
maximum 0.40 wt. % chromium and nickel, preferably less than 0.20 wt. % chromium and nickel;
niobium, titanium, vanadium and boron with less than 0.10 wt. % each, preferably titanium, vanadium and boron with less than 0.05 wt. %;
maximum 70 ppm nitrogen, preferably less than 50 ppm nitrogen;
optionally other elements without iron with a part of less than 1.0 wt. %, which are specifically alloyed or which enter the melt as an unavoidable admixture via the starting materials; and
residual iron content.

It should be expressly noted that the subject matter of the third aspect can advantageously be combined with the subject matter of the preceding aspects of the invention, both individually and cumulatively in any combination.

Further advantages, details and features of the invention can be found below in the described embodiments. In the figures, in detail:

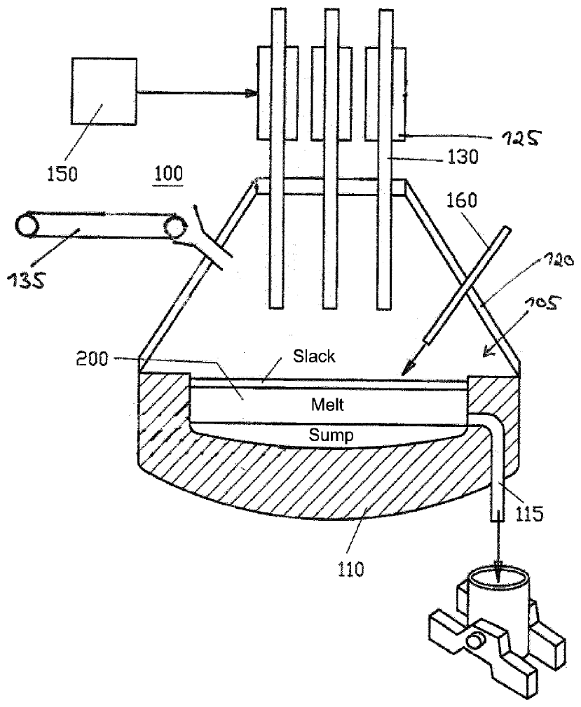

FIG. 1 shows a schematic diagram of an electric arc furnace.

In the description below, individual features that have been described in connection with one embodiment can also be used separately in other embodiments.

The electric arc furnace 100 in FIG. 1 substantially comprises a furnace vessel 105 with at least one electrode 130 and a voltage supply 150 connected to the at least one electrode 130, wherein the furnace vessel 105 has a lower vessel 110 for receptacle of a melt 200 and a cover 120 for placing on the lower vessel 110.

The lower vessel 110 has a tapping channel 115, via which the melt 200 can leave the furnace vessel 105.

The cover 120 has a retaining means 125 for fastening the at least one electrode 130.

In accordance with a first embodiment, the electric arc furnace 100 is configured to determine a nitrogen content in the melt 200.

In accordance with a second embodiment, the electric arc furnace 100 is configured to reduce the nitrogen content in the melt 200 to less than or equal to 70 ppm, preferably to less than or equal to 55 ppm and particularly preferably to less than or equal to 45 ppm.

The first embodiment and the second embodiment of the electric arc furnace 100 can be combined with one another.

Furthermore, the electric arc furnace 100 preferably has a conveyor system 135 which is configured for conveying a carbon carrier (not shown), particularly for conveying directly reduced iron (not shown).

Preferably, the conveyor system 135 is configured to convey the carbon carrier (not shown) at a temperature of the carbon carrier (not shown) of greater than or equal to 500° C., preferably greater than or equal to 600° C. and more preferably greater than or equal to 700° C.

Preferably, the conveyor system 135 is controllable with respect to an amount of the conveyed carbon carrier (not shown), particularly with respect to a conveyor speed of the conveyor system 135.

Optionally, the electric arc furnace 100 has an apparatus for the insertion of oxygen 160.

### LIST OF REFERENCE SIGNS

100 electric arc furnace
105 furnace vessel
110 lower vessel
115 tapping channel
120 cover
125 retaining means
130 electrode
135 conveyor system
150 voltage supply
160 apparatus for the insertion of oxygen
200 melt

1. An electric arc furnace (100) having a furnace vessel (105) with at least one electrode (130) and a voltage supply (150) connected to the at least one electrode (130), wherein the furnace vessel (105) has a lower vessel (110) for receptacle of a melt (200) and a cover (120) for fastening onto the lower vessel (110), wherein the lower vessel (110) has a tapping channel (115), and wherein the cover (120) has a holding means (125) for fastening the at least one electrode (130),
characterized in that
the electric arc furnace (100) is configured to determine a nitrogen content in the melt (200)
and/or
in that the electric arc furnace (100) is configured to reduce the nitrogen content in the melt (200) to less than or equal to 70 ppm, preferably to less than or equal to 55 ppm and particularly preferably to less than or equal to 45 ppm.

2. The electric arc furnace (100) according to claim 1, characterized in that the electric arc furnace (100) has a conveyor system (135) for conveying a carbon carrier, in particular for conveying directly reduced iron.

3. The electric arc furnace (100) according to claim 2, characterized in that the electric arc furnace (100) and/or the conveyor system (135) is configured to convey the carbon carrier at a temperature of the carbon carrier of more than or equal to 500° C., preferably of more than or equal to 600° C. and particularly preferably of more than or equal to 700° C.

4. The electric arc furnace (100) according to one of claim 2 or 3, characterized in that the electric arc furnace (100) and/or the conveyor system (135) is configured for conveying the carbon carrier during operation of the electric arc furnace (100), particularly for continuous conveying of the carbon carrier.

5. The electric arc furnace (100) according to any of claims 2 to 4, characterized in that the electric arc furnace (100) and/or the conveyor system (135) is controllable with respect to an amount of the conveyed carbon carrier, particularly with respect to a conveyor speed of the conveyor system (135).

6. The electric arc furnace (100) according to claim 5, characterized in that the electric arc furnace (100) and/or the conveyor system (135) is controlled in such a way that the melt (200) has a carbon content of less than or equal to 2.06 wt. %.

7. The electric arc furnace (100) according to any of the preceding claims, characterized in that the electric arc furnace (100) has an apparatus for the insertion of oxygen (160).

8. The electric arc furnace (100) according to any of the preceding claims, characterized in that the electric arc furnace (100) is configured to remove nitrogen in a gas phase.

9. The electric arc furnace (100) according to any of the preceding claims, characterized in that the voltage supply (150) has a control which is operatively connected to the temperature of the melt (200).

10. A method of operating an electric arc furnace (100) according to any of claims 1 to 9, characterized in that a melt (200) with a nitrogen content of less than or equal to 70 ppm is produced, preferably less than or equal to 55 ppm and particularly preferably less than or equal to 45 ppm.

11. The method according to claim 10, characterized in that the nitrogen content in the melt (200) is determined during operation of the electric arc furnace (100).

12. The method according to any of claim 10 or 11, characterized in that the electric arc furnace (100) and/or a conveyor system (135) and/or a voltage supply (150) is controlled.

13. A use of an electric arc furnace (100) according to any of claims 1 to 9 for the production of a melt (200) having a nitrogen content of less than or equal to 70 ppm, preferably less than or equal to 55 ppm and particularly preferably less than or equal to 45 ppm.
